(19) United States
(12) Patent Application Publication
(10) Pub. No.: US 2020/0303145 A1
(43) Pub. Date: Sep. 24, 2020

(54) RELAY

(71) Applicant: FUJITSU COMPONENT LIMITED, Tokyo (JP)

(72) Inventor: Takuji Murakoshi, Tokyo (JP)

(21) Appl. No.: 16/783,477

(22) Filed: Feb. 6, 2020

(30) Foreign Application Priority Data
Mar. 19, 2019 (JP) 2019-051034

(51) Int. Cl. H01H 50/54; H01H 50/36; H01H 50/02; H01H 50/14; H01H 9/44

(52) U.S. Cl. CPC H01H 50/54; H01H 50/36; H01H 9/443; H01H 50/14; H01H 50/021

(57) ABSTRACT

Provided is a relay having a relatively small dimension in an alignment direction of contacts, having an easily assembled structure, and capable of extinguishing arcs generated at each contact. The relay comprises: a first terminal having a pair of first contacts; a second terminal having a pair of second contacts which are opposed to the pair of first contacts so as to contact and separate from the respective first contacts; and a first magnet positioned on a side opposed to the pair of first contacts of the first terminal and between the pair of first contacts so that the first magnet does not contact the first terminal, wherein the first magnet is magnetized in a direction along which the pair of first contacts and the pair of second contacts are opposed.

### RELAY

This application is based upon and claims the benefit of priority of the prior Japanese Patent Application No. 2019-051034, filed Mar. 19, 2019, the entire contents of which are incorporated herein by reference.

### TECHNICAL FIELD

The present invention relates to a relay.

### BACKGROUND

Relays (electromagnetic relays) comprise an electromagnet, an armature, a movable terminal including a movable contact, and a fixed terminal including a fixed contact. In such relays, the armature is moved by the excitation of the electromagnet, whereby the armature is pressed against the movable terminal, and contact between the movable contact and the fixed contact come is established.

JP 5085754 B discloses a relay with an opening/closing part including one movable contact piece having a pair of movable contact and two fixed contact piece each having one fixed contact. This relay has an arc-extinguishing member including a permanent magnet for extinguishing an arc generated at the opening/closing part and a connecting member made from magnetic material for magnetically connecting the permanent magnet.

JP 5202072 B discloses a relay with two opening/closing parts respectively having a movable terminal with one movable contact and a fixed terminal with one fixed contact, wherein the opening/closing parts constitute separate circuits. A permanent magnet is provided to each opening/closing part, and each permanent magnet extinguishes an arc generated at the corresponding opening/closing part.

### SUMMARY

In a relay having a contact structure including a plurality of movable contacts and a plurality of fixed contacts, a structure for arc-extinguishing may be complicated, the relay may increase in size, and a degree of difficulty in assembling the relay may be increased.

One aspect of the present invention is a relay comprising: a first terminal having a pair of first contacts; a second terminal having a pair of second contacts which are opposed to the pair of first contacts so as to contact and separate from the respective first contacts; and a first magnet positioned on a side opposed to the pair of first contacts of the first terminal and between the pair of first contacts so that the first magnet does not contact the first terminal, wherein the first magnet is magnetized in a direction along which the pair of first contacts and the pair of second contacts are opposed.

According to the relay of the one aspect, by virtue of the location of the first magnet and the magnetizing direction, the arcs, generated at two sets of contacts constituted by the first and second contacts, can be elongated in a direction different from the alignment direction of the first (or second) contacts and can be extinguished. As a result, the distance between the first (or second) contacts in the alignment direction can be increased, and the arcs generated at the two sets of contacts can be extinguished. Moreover, the arc can be extinguished by a simple structure, and the relay can be easily assembled.

### BRIEF DESCRIPTION OF DRAWINGS

FIG. 1 is an exploded perspective view of a relay according to an embodiment;

FIG. 2 is a top view of an inner structure of the relay;

FIGS. 3A and 3B are views explaining a motion of an armature;

FIG. 4 is a view of a positional relationship of components of the relay;

FIG. 5 is a view of a location of a first magnet viewed in a direction V of FIG. 4;

FIG. 6 is a side view of the first magnet;

FIG. 7 is a view of locations of the first magnet and a yoke according to a modification;

FIG. 8 is a view of locations of the first magnet and a second magnet according to a modification;

FIG. 9 is an exploded perspective view of an attachment member and the other components of the modification;

FIGS. 10A and 10B are views explaining a fixing method of the attachment member of FIG. 9;

FIG. 11 is an exploded perspective view of a yoke and the other components of the modification;

FIG. 12 is a view of a positional relationship of components of the modification; and

FIG. 13A and 13B are views explaining a fixing method of the first magnet of the modification.

### DETAILED DESCRIPTION

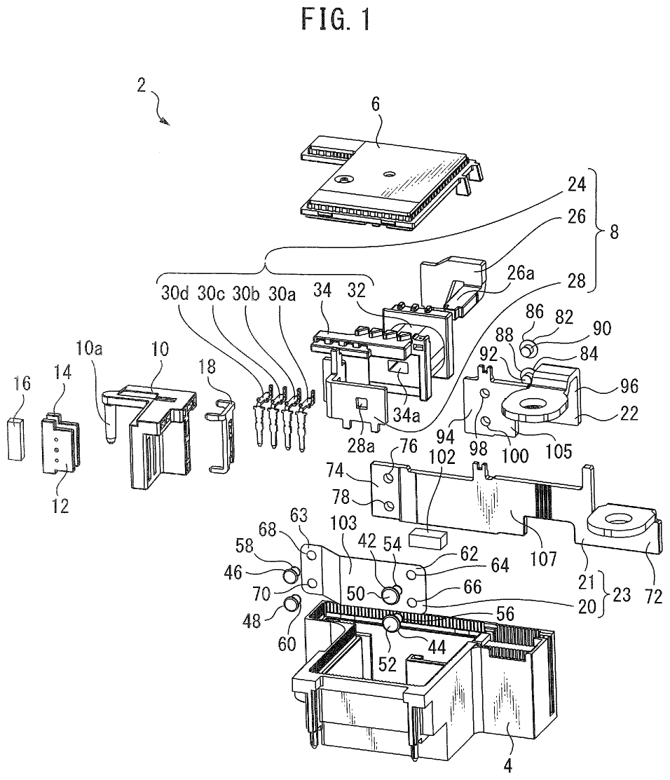

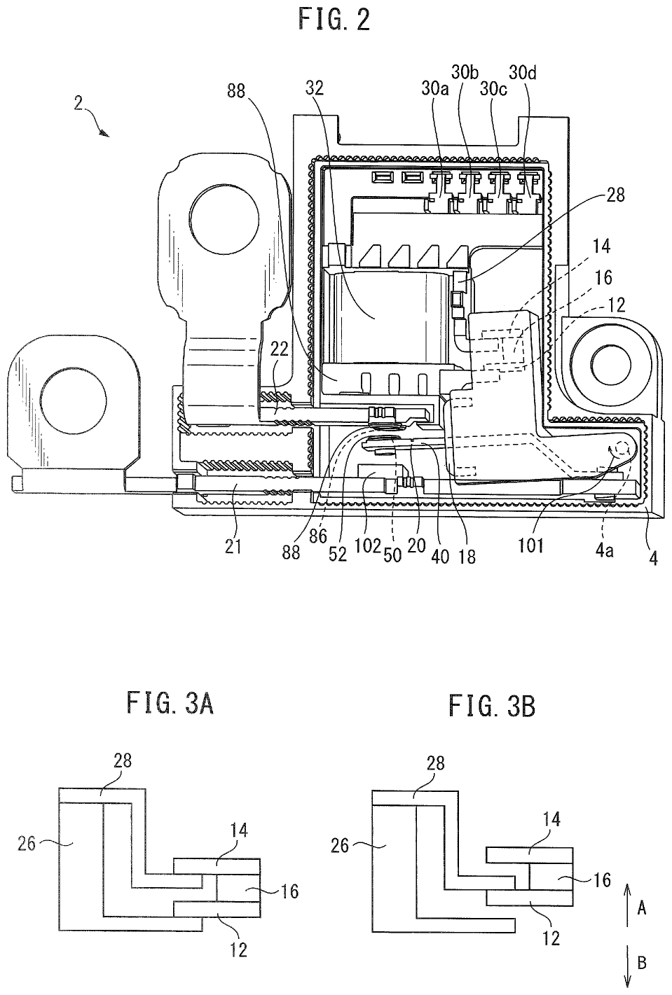

An embodiment of the present disclosure will be described below with reference to the attached drawings. FIG. 1 is an exploded perspective view of a relay 2. The relay 2 comprises a housing 4 in which various components are incorporated, and a cover 6 attached to the housing 4. The housing 4 and the cover 6 may, for example, be formed from resin. FIG. 2 is a top view of the relay 2 while the cover 6 is removed.

The components incorporated in the housing 4 include an electromagnet 8, an actuator 10, a pair of plate-like armatures 12, 14, a permanent magnet 16, a card 18, a first terminal 20, a conductive base 21, and a second terminal 22. The electromagnet 8 includes a coil assembly 24, an iron core 26, and a yoke 28.

The coil assembly 24 includes four coil terminals 30a, 30b, 30c, 30d, a coil 32 having two wirings, and a bobbin 34 on which the coil 32 is wound. The coil terminals 30a, 30c are connected to one of the wirings of the coil 32, and coil terminals 30b, 30d are connected to the other wiring. The bobbin 34 may, for example, be formed from resin.

A shaft 26a of the iron core 26 is inserted into a cavity 34a of the bobbin 34 and a hole 28a of the yoke 28, so that the shaft is positioned at the center of the coil 32.

By inserting a shaft 10a of the actuator 10 into a hole 4a of the hosing 4, the actuator 10 is attached to the housing 4 rotatably about the shaft 10a. The actuator 10 may, for example, be formed from resin.

The armatures 12, 14 and the card 18 are attached to the actuator 10. The armatures 12, 14 may be formed from magnetic material such as iron.

The permanent magnet 16 is positioned between the armatures 12, 14, and the permanent magnet 16 and the armatures 12, 14 form a magnetic path.

The first terminal 20 has a pair of contact members 42, 44 attached to a front end 62. The contact member 42 has a first contact 50, and an attachment part 54 attached to the front end 62. The contact member 44 has a first contact 52, and an attachment part 56 attached to the front end 62.

The first terminal 20 has a first extended part 103 extending from the front end 62, and a proximal end 63 positioned at the opposite side of the front end 62 with respect to the first extended part 103. In this embodiment, the front end 62, the first extended part 103 and the proximal end 63 are configured by a plate having conductivity and springiness.

Holes 64, 66 are formed on the front end 62. By inserting the attachment parts 54, 56 into the holes 64, 66, respectively, and then swaging the attachment parts, the first contacts 50, 52 are fixed to the front end 62. The first contacts 50, 52 are electrically connected via a plate having conductivity.

The first terminal 20 is connected to the base 21 by connecting members 46, 48. The base 21 has a front end 72 exposed to the outside of the relay 2, an extended part 107 extending from the front end 72, and a proximal end 74 positioned at the opposite side of the front end 72 with respect to the first extended part 107.

Holes 68, 70 are formed on the proximal end 63, and holes 76, 78 are formed on the proximal end 74. While the hole 68 is superimposed on the hole 76 and the hole 70 is superimposed on the hole 78, by inserting the attachment parts 58 into the holes 68, 76 and inserting the attachment parts 60 into the holes 70, 78, and then swaging the attachment parts, the first terminal 20 is fixed to the base 21.

The base 21 supports the first terminal 20 including the plate having springiness, and constitutes a movable terminal 23. The first terminal 20 and the base 21 may, for example, be formed from a metal plate.

The second terminal 22 has a pair of contact members 82, 84 attached to a front end 94. The contact member 82 has a second contact 86, and an attachment part 90 attached to the front end 94. The contact member 84 has a second contact 88, and an attachment part 92 attached to the front end 94.

The second terminal 22 has a second extended part 105 extending from the front end 94, and a proximal end 96 positioned at the opposite side of the front end 94 with respect to the second extended part 105. The front end 94, the second extended part 105 and the proximal end 96 are configured by a plate having conductivity.

Holes 98, 100 are formed on the front end 94. By inserting the attachment parts 90, 92 into the holes 98, 100, respectively, and then swaging the attachment parts, the second contacts 86, 88 are fixed to the front end 94. The second contacts 86, 88 are electrically connected via a plate having conductivity.

The second contact 86 and the first contact 50 are opposed to each other so that they can contact and separate from each other, and the second contact 88 and the first contact 52 are opposed to each other so that they can contact and separate from each other. The first contacts 50, 52 are electrically connected to each other, and the second contacts 86, 88 are electrically connected to each other. Therefore, the contact structure of this embodiment is a twin contact structure in which an opening/closing motion is performed by the electrically connected first contacts 50, 52 and the electrically connected second contacts 86, 88. A set of the second contact 86 and the first contact 50 and a set of the second contact 88 and the first contact 52 are electrically connected to each other in parallel, when the closing motion of the relay 2 is performed.

With reference to FIGS. 2, 3a and 3b, the opening/closing motion of the relay 2 is explained. FIGS. 3a and 3b show a positional relationship between the armatures 12, 14 attached to the actuator 10, the permanent magnet 16, the iron core 26, and the yoke 28. In this embodiment, the first terminal is the movable terminal, and the second terminal 22 is the fixed terminal.

FIG. 3A shows the positional relationship between the first contacts 50, 52 and the second contacts 86, 88 when the contacts are separated from each other, and FIG. 3B shows the positional relationship between the first contacts 50, 52 and the second contacts 86, 88 when the contacts contact each other.

In FIG. 3A, the armatures 12, 14 are adsorbed to the iron core 26 and the yoke 28, respectively. In FIG. 3B, the armature 14 is separated from the yoke 28, and the armature 12 is adsorbed to the yoke 28. When the electromagnet 8 is not excited, one of the positional relationships of FIGS. 3a and 3b is maintained, due to a magnetic force of the permanent magnet 16. Hereinafter, the arrangement of FIGS. 3a is explained as a state before the electromagnet 8 is excited.

In the relay 2, a voltage is applied between the coil terminals 30a, 30c so as to excite the electromagnet 8 and generate a magnetic force in a direction A of FIG. 3B larger than the magnetic force of the permanent magnet 16. Due to this, the armatures 12, 14 and the permanent magnet 16 are shifted from the positions of FIG. 3A to the positions of FIG. 3B. According to the shift, the actuator 10 is rotated in a direction of an arrow 101 of FIG. 2, the card 18 interlocking with the actuator 10 presses and moves the first terminal 20 in the vertical direction of FIG. 2, and the first contacts 50, 52 come into contact with the second contacts 86, 88, respectively.

On the other hand, a voltage is applied between the coil terminals 30b, 30d so as to excite the electromagnet 8 and generate a magnetic force in a direction B of FIG. 3B larger than the magnetic force of the permanent magnet 16. Due to this, the armatures 12, 14 and the permanent magnet 16 are shifted from the positions of FIG. 3B to the positions of FIG. 3A. According to the shift, the actuator 10 is rotated in the opposite direction of the arrow 101, the pressing force of the card 18 against the first terminal 20 is released, and the first contacts 50, 52 are separated from the second contacts 86, 88, respectively.

Due to the above configuration, the relay 2 opens/closes the first contacts 50, 52 and the second contacts 86, 88. This embodiment is merely an example, and thus an arbitrary configuration may be used for the opening/closing motion. The opening/closing motion may be performed by inverting each direction of the applied voltage between the coil terminals 30a, 30c and between the coil terminals 30b, 30d. Further, the first terminal 20 may be the fixed terminal, and the second terminal 22 may be the movable terminal.

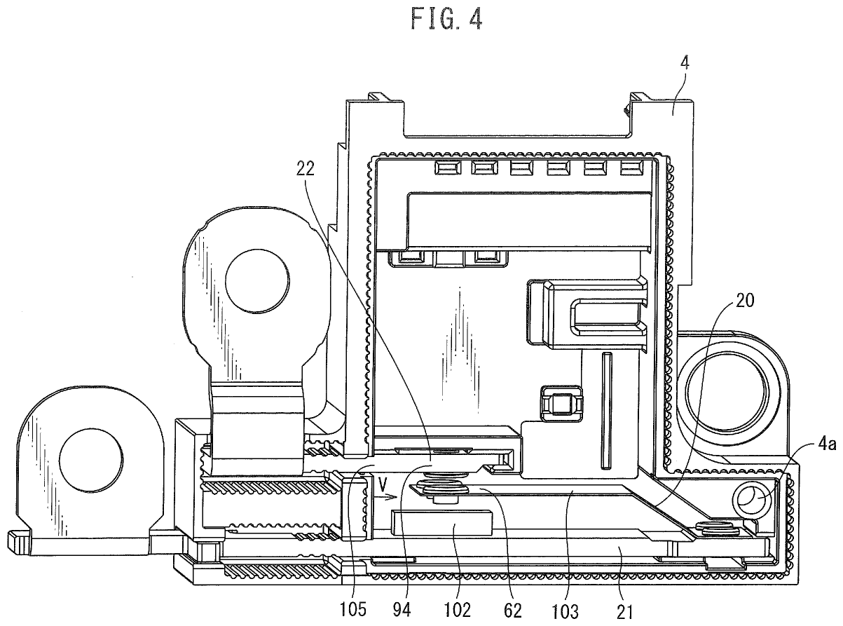

With reference to FIGS. 4 to 6, a first magnet 102 is explained. FIGS. 4, 5 and 6 show the positional relationship between the first terminal 20, the base 21, the second terminal 22 and the first magnet 102. The first magnet 102 of FIG. 4 is formed as a rectangular parallelepiped. The first magnet 102 may, for example, be formed from ferrite, samarium-cobalt, or neodymium, etc.

When the difference in the electrical potentials is generated between the first terminal 20 and the second terminal 22 during the opening/closing motion, an arc may be generated between the first contact 50 and the second contact 86 and/or between the first contact 52 and the second contact 88. The first magnet 102 is provided to the relay 2 in order to extinguish the arc.

The first magnet 102 is positioned on a side opposed to the first contacts 50, 52 of the first terminal 20 and on a position corresponding to between the pair of first contacts 50, 52 so that the first magnet 102 does not contact the first terminal 20. The illustrated first magnet 102 is positioned on a surface 21a of the base 21 and equidistant from the first contacts 50, 52.

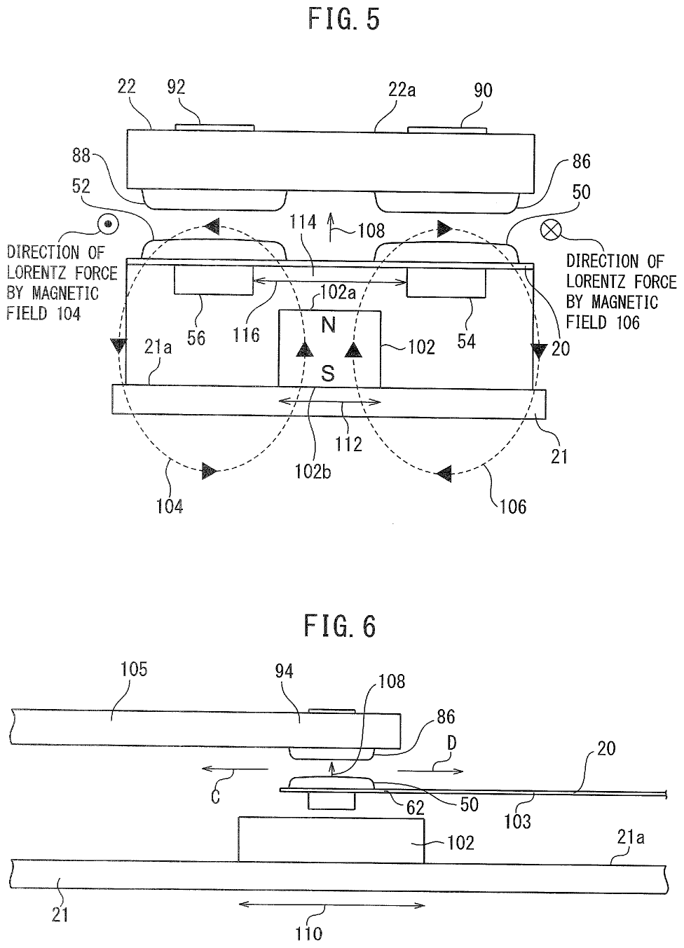

The first magnet 102 is magnetized in a direction along which the first contacts 50, 52 and the second contacts 86, 88 are opposed. As exemplified in FIG. 5, the first magnet 102 is magnetized so that a surface 102a near the first contacts 50, 52 has a polarity of N-pole and a surface 102b far from the first contacts 50, 52 has a polarity of S-pole, whereby magnetic fluxes 104, 106 are generated.

Hereinafter, a principle for extinguishing an arc by the first magnet 102 is explained, by using an example wherein the current flows from the first terminal 20 to the second terminal 22 via the first contacts 50, 52 and the second contacts 86, 88, in a direction of an arrow 108 of FIG. 5.

Between the first contact 52 and the second contact 88, the flux 104 acts in the left direction in FIG. 5. Therefore, based on Fleming's left-hand rule, a Lorentz force acts from a back side to a front side of FIG. 5, between the first contact 52 and the second contact 88. As a result, the arc is elongated in a direction C in FIG. 6, and then is extinguished.

Between the first contact 50 and the second contact 86, the flux 106 acts in the right direction in FIG. 5. Therefore, based on Fleming's left-hand rule, a Lorentz force acts from the front side to the back side of FIG. 5, between the first contact 50 and the second contact 86. As a result, the arc is elongated in a direction D in FIG. 6, and then is extinguished.

When the current flows in the opposite direction of the arrow 108 in FIG. 5, based on Fleming's left-hand rule, the directions of the Lorentz force due to the fluxes 104, 106 are opposite to the directions as described above. Therefore, the arc generated between the first contact 52 and the second contact 88 is elongated in the direction D, the arc generated between the first contact 50 and the second contact 86 is elongated in the direction C, and then the arcs are extinguished.

Due to the above configuration, the arcs generated between the first contact 52 and the second contact 88 and between the first contact 50 and the second contact 86 can be extinguished, without locating the first magnet 102 in the juxtaposing direction of the first contacts 50, 52 or the second contacts 86, 88. Further, the arc is not elongated in the juxtaposing direction of the first contacts 50, 52 or the second contacts 86, 88. As a result, in the relay 2, the dimension in the juxtaposing direction of the first contacts 50, 52 or the second contacts 86, 88 can be reduced, while ensuring the arc-extinguishing property. Moreover, since the arc can be extinguished by a simple structure, the assembling of the relay is facilitated.

In addition, the first magnet 102 may be magnetized so that the surface 102a is the S-pole and the surface 102b is the N-pole.

As shown in FIGS. 4 and 6, the first extended part 103 and the second extended part 105 extend in opposite directions to each other. By locating the conductive first extended part 103 or the conductive second extended part 105 in the direction C or D along which the arc is elongated, the arc is elongated so as to be moved on the first extended part 103 and the second extended part 105 without staying at the first contacts 50, 52 or the second contacts 86, 88, whereby the arc can be assuredly extinguished.

A width 110 of the first magnet 102 along the extending direction of the first extended part 103 and the second extended part 105 is larger than dimensions of the first magnet in the other directions. For example, the width 110 is longer than a width 112 in the juxtaposing direction of the first contacts 50, 52 or the second contacts 86, 88. By extending the first magnet 102 in the elongating direction of the arc, a high-density flux is generated in a space to which the arc is elongated, whereby the arc can be assuredly extinguished.

As shown in FIG. 5, the width 112 of the first magnet 102 corresponds to a dimension received in a space 114 between the attachment parts 54, 56. For example, the width 112 is shorter than a width 116 of the space 114. The first terminal 20 is moved in the vertical direction in FIG. 5, corresponding to the opening/closing motion of the relay 2. Therefore, in view of a movable range of the first terminal 20, it is necessary to locate the first magnet 102 so that it does not contact the first terminal 20.

By setting the width 112 of the first magnet 102 to the dimension as described above, even when the first terminal 20 is displaced downward in FIG. 5, the first magnet 102 can be positioned close to the first terminal 20 without contacting the attachment parts 54, 56. As a result, the first magnet 102 is positioned so that the flux densities between the first contact 52 and the second contact 88 and between the first contact 50 and the second contact 86 are increased, whereby the arc can be assuredly extinguished.

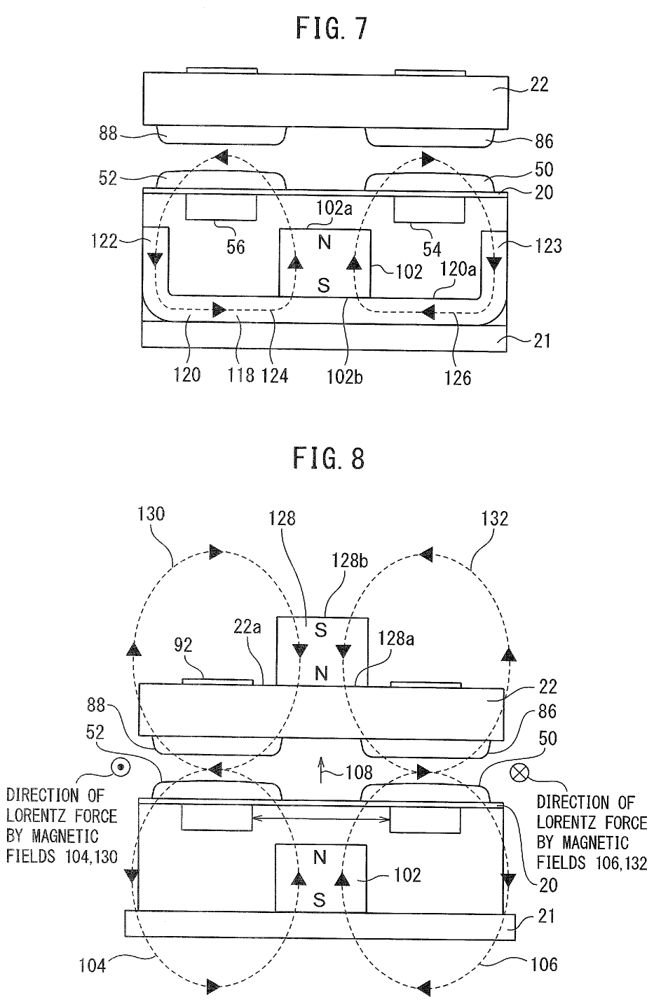

FIG. 7 shows a modification including a yoke 118. In FIG. 7, the positional relationship, the shapes and the sizes of the first terminal 20, the second terminal 22 and the first magnet 102, and the polarity of the first magnet 102, are the same as FIG. 5. The yoke 118 has a bottom 120 and walls 122, 123 which are bent from the bottom 120 and extend toward the first terminal 20. The yoke 118 may be formed from magnetic material such as iron.

The first magnet 102 is adhered to the surface 120a of the yoke 118 by an adhesive such as epoxy resin, so as to form a magnetic path. A magnetic flux 124 passes through the wall 122 and the bottom 120, and a magnetic flux 126 passes through the wall 123 and the bottom 120, whereby the fluxes 124 and 126 can be concentrated between the first contact 52 and the second contact 88 and between the first contact 50 and the second contact 86, respectively, without being dispersed. Therefore, by using the yoke 118, the flux densities between the first contact 50 and the second contact 86 and between the first contact 52 and the second contact 88 can be further increased, and the arc-extinguishing property can be further improved.

FIG. 8 shows a modification including a second magnet 128. In FIG. 8, the positional relationship, the shapes and the sizes of the first terminal 20, the second terminal 22 and the first magnet 102, and the polarity of the first magnet 102, are the same as FIG. 5. For example, the second magnet 128 has the same shape and size as the first magnet 102. The second magnet 128 may, for example, be formed from ferrite, samarium-cobalt, or neodymium, etc.

The second magnet 128 is positioned on a side opposed to the second contacts 86, 88 of the second terminal 22 and on a position corresponding to between the pair of second contacts 86, 88 so that the second magnet 128 contacts the second terminal 22. The second magnet 128 of FIG. 8 is positioned on a surface 22a of the second terminal 22, between the attachment parts 90, 92, and equidistant from the second contacts 86, 88.

The second magnet 128 is magnetized in a direction along which the first contacts 50, 52 and the second contacts 86, 88 are opposed, so that the second magnet has a reverse polarity to the polarity of the first magnet 102. The second magnet 128 of FIG. 8 is magnetized so that a surface 128a near the second contacts 86, 88 has a polarity of N-pole and a surface 128b far from the second contacts 86, 88 has a polarity of S-pole, whereby magnetic fluxes 130, 132 are generated.

Hereinafter, a principle for extinguishing an arc by the first magnet 102 and the second magnet 128 is explained, by using an example wherein the current flows from the first terminal 20 to the second terminal 22 via the first contacts 50, 52 and the second contacts 86, 88, in a direction of the arrow 108 of FIG. 8. Note that the explanation of the first magnet 102 is omitted, since the first magnet 102 acts on the arc similarly to the above.

In the above magnetizing direction, the directions of the fluxes 130 and 104 are the same between the first contact 52 and the second contact 88. Therefore, based on Fleming's left-hand rule, a Lorentz force acts from a back side to a front side of FIG. 8, between the first contact 52 and the second contact 88. As a result, the arc is subject to a resultant force of the Lorentz force due to the flux 104 and the Lorentz force due to the flux 130.

Further, the directions of the fluxes 132 and 106 are the same between the first contact 50 and the second contact 86. Therefore, based on the Fleming's left-hand rule, a Lorentz force acts from the front side to the back side of FIG. 8, between the first contact 50 and the second contact 86. As a result, the arc is subject to a resultant force of the Lorentz force due to the flux 106 and the Lorentz force due to the flux 132.

Accordingly, by arranging the second magnet 128 as well as the first magnet 102, the larger force can be applied to the arcs generated between the first contact 50 and the second contact 86 and between the first contact 52 and the second contact 88, whereby the arc-extinguishing property can be further improved.

Note that the first magnet 102 and the second magnet 128 may be magnetized so that each magnet has a reverse polarity to the polarity as shown in FIG. 8. The second magnet 128 may be arranged so as not to contact the second terminal 22. Moreover, the relay 2 may not have the first magnet 102 and may be configured to extinguish the arc by arranging the second magnet 128.

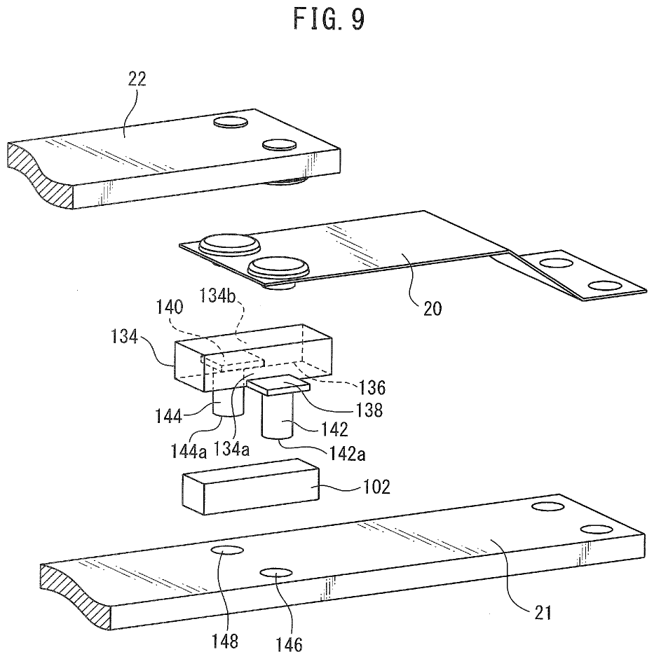

FIG. 9 is an exploded perspective view showing the positional relationship between the components of a modification including an attachment member 134. In FIG. 9, the positional relationship between the first terminal 20, the base 21, the second terminal 22 and the first magnet 102 may be the same as in FIGS. 4 to 6.

The attachment member 134 is a member for attaching the first magnet 102 to the base 21, and may be formed, for example, from resin. For example, the attachment member 134 is formed as a box, and the first magnet 102 is contained in a containing part 136 which opens downward in FIG. 9.

The attachment member 134 has an extended plate 138 extending from an outer surface 134a toward the outside of the containing part 136, and an extended plate 140 extending from an outer surface 134b opposed to the outer surface 134a toward the outside of the containing part 136. Columnar protrusions 142, 144 extending downward in FIG. 9 are formed on the extended plates 138, 140, respectively. A pair of holes 146, 148 are formed on the base 21. By inserting the protrusion 142, 144 into the holes 146, 148, respectively, and then swaging the protrusions, the attachment member 134 is fixed to the base 21.

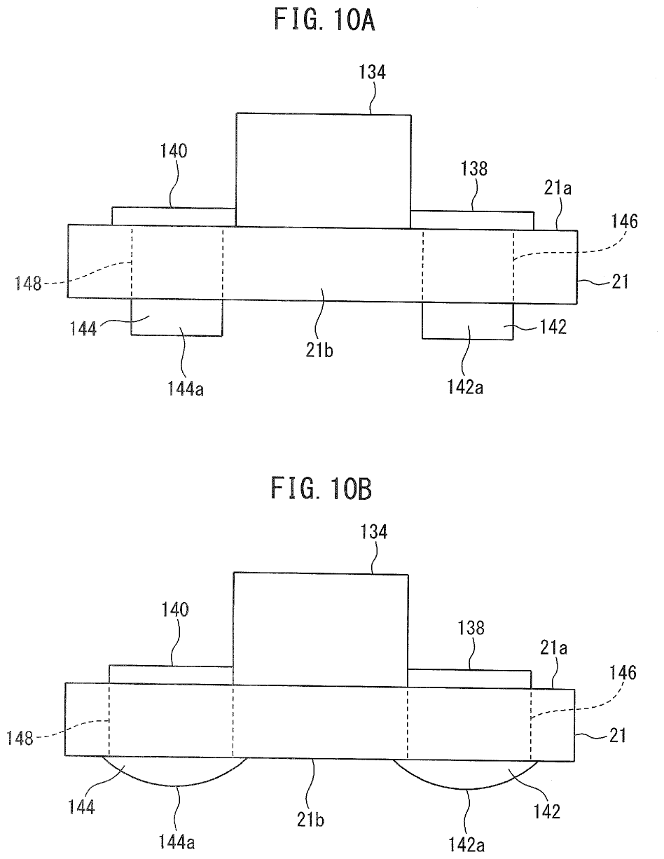

FIGS. 10a and 10b are views explaining a fixing method of the attachment member 134 of FIG. 9. FIG. 10A shows a state before the attachment 134 is fixed, and FIG. 10B shows a state after the attachment 134 is fixed.

As shown in FIG. 10A, while the protrusions 142, 144 are inserted into the holes 146, 148, respectively, a front end 142a of the protrusion 142 and a front end 144a of the protrusion 144 protrude at a surface 21b of the base 21. As shown in FIG. 10B, by plastically deforming (e.g., by heating) the protruded front ends 142a and 144a, the attachment member 134 is fixed to the base 21. Note that this embodiment is merely an example, and an arbitrary shape and an arbitrary fixing method can be applied to the attachment member 134.

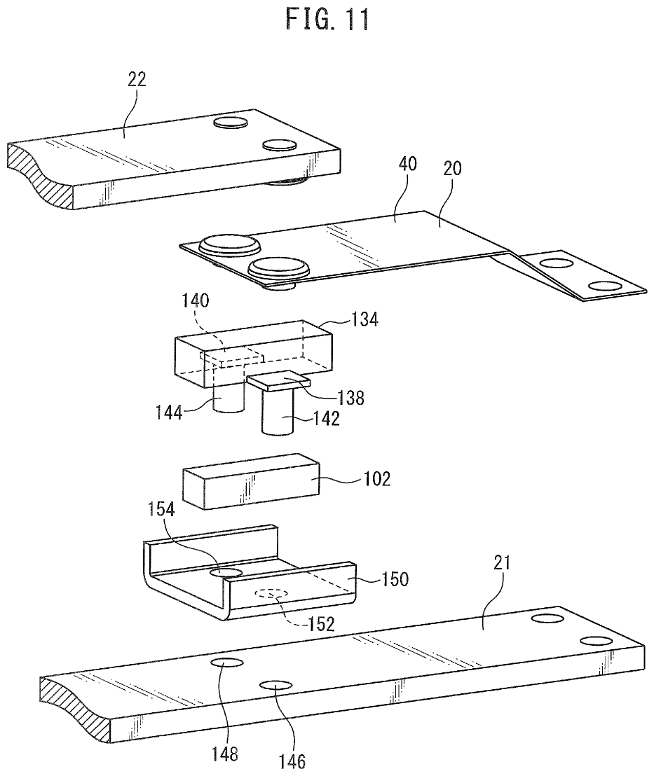

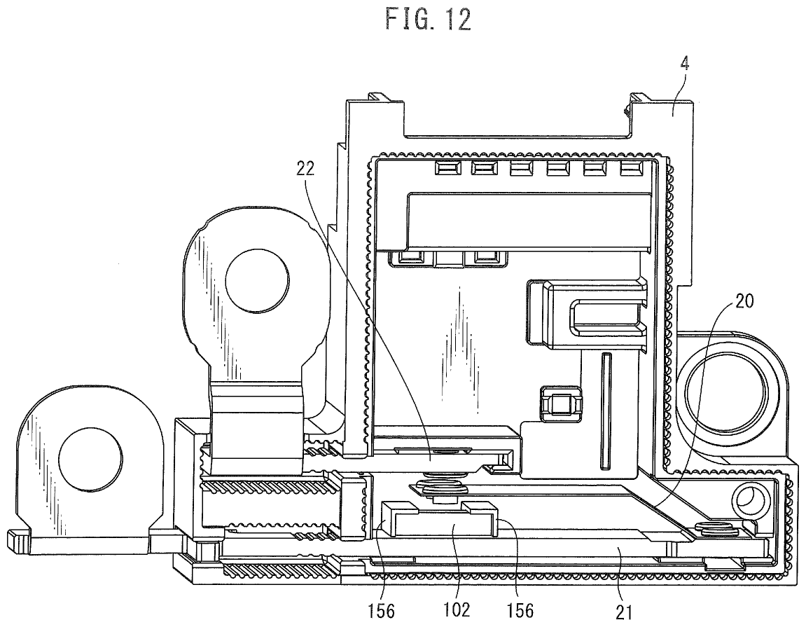

FIG. 11 is an exploded perspective view showing a positional relationship between components of a modification including a yoke 150. In FIG. 11, the positional relationship between the components except for the yoke 150 may be the same as FIG. 9. The yoke 150 may be formed from magnetic material such as iron, and may have the same shape and the size of the yoke 118 of FIG. 7. The yoke 150 is positioned between the attachment member 134 and the base 21, is attached to the first magnet 102, and forms a magnetic path.

As shown in FIG. 11, the yoke 150 has through holes 152, 154, through which the protrusions 142, 144 are inserted, respectively. The protrusion 142 passes through the hole 152, is inserted into the hole 146, and then is swaged. The protrusion 144 passes through the hole 154, is inserted into the hole 148, and then is swaged. By swaging the protrusions 142, 144, the attachment member 134 fixes the yoke 150 to the base 21.

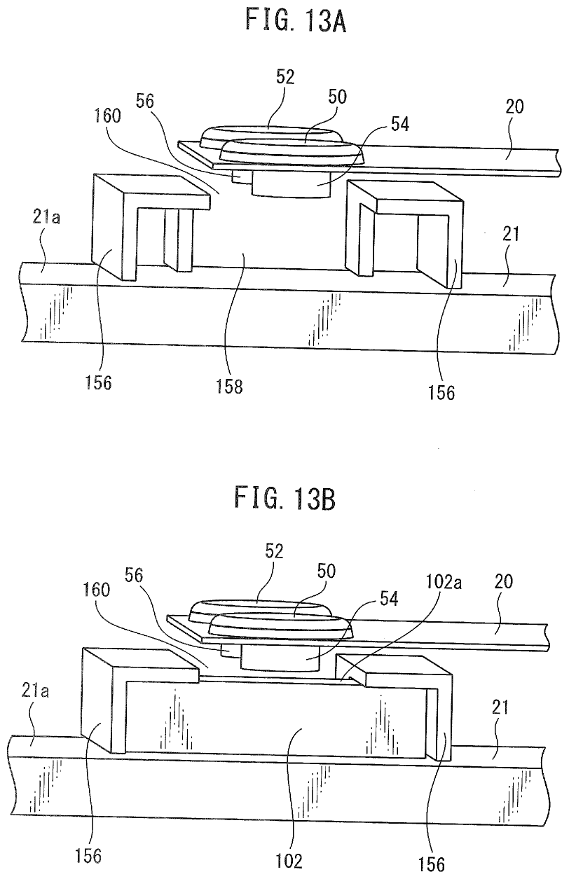

With reference to FIGS. 12 to 13b, another modification is explained. FIG. 12 shows a positional relationship between components of the modification. FIGS. 13a and 13b are partial enlarged views of FIG. 12. FIG. 13A shows a state before the first magnet 102 is fixed, and FIG. 13B shows a state after the first magnet 102 is fixed.

The housing 4 has a wall 156 for holding the first magnet 102. The wall 156 forms a space 158 cooperatively with the base 21. The first magnet 102 is positioned in the space 158, and is held by and fixed to the wall 156.

The wall 156 has a gap 160 at a position between the first contacts 50, 52. The surface 102a of the first magnet 102 is partially exposed from the gap 160 and is opposed to the first terminal 20. By providing the gap 160 in the wall 156, the first magnet 102 can be positioned close to the first terminal 20, without taking the thickness of the wall 156 into consideration. As a result, high-density fluxes are generated between the first contact 50 and the second contact 86 and between the first contact 52 and the second contact 88, and the arc-extinguishing property can be obtained. Further, since the fixing structure is formed integrally with the housing 4, the first magnet 102 can be fixed without increasing the number of components.

The wall 156 may have an arbitrary shape and may be configured so that it holds the first magnet 102 and is attached to the base 21 by the attachment member 134.

The embodiments described above can be appropriately combined. Furthermore, in the drawings described above, identical or corresponding portions are assigned the same reference signs. Note that the embodiments described above are merely exemplary and do not limit the invention.

1. A relay comprising:
a first terminal having a pair of first contacts;
a second terminal having a pair of second contacts which are opposed to the pair of first contacts so as to contact and separate from the respective first contacts; and
a first magnet positioned on a side opposed to the pair of first contacts of the first terminal and between the pair of first contacts so that the first magnet does not contact the first terminal,
wherein the first magnet is magnetized in a direction along which the pair of first contacts and the pair of second contacts are opposed.

2. The relay according to claim 1, wherein the first terminal has a front end configured to support the pair of first contacts, and a first extended part extending from the front end of the first terminal,
the second terminal has a front end configured to support the pair of second contacts, and a second extended part extending from the front end of the second terminal, and
the first extended part and the second extended part extend in opposite directions to each other.

3. The relay according to claim 1,
wherein the first terminal has a front end configured to support the pair of first contacts, and a first extended part extending from the front end of the first terminal,
wherein the second terminal has a front end configured to support the pair of second contacts, and a second extended part extending from the front end of the second terminal, and
wherein a dimension of the first magnet in an extending direction of the first extended part and the second extended part is larger than a dimension of the first magnet in another direction.

4. The relay according to claim 1,
wherein the first terminal has a front end configured to support the pair of first contacts, and a pair of contact members each having the first contact and an attachment part configured to attach the first contact to the front end, and
wherein the first magnet has a dimension received in a space between the attachment parts of the pair of contact members.

5. The relay according to claim 1,
wherein the relay has a second magnet positioned on a side opposed to the pair of second contacts of the second terminal and between the pair of second contacts so that the second magnet contacts the second terminal, and
wherein the second magnet is magnetized in a direction along which the pair of first contacts and the pair of second contacts are opposed, so that the second magnet has a reverse polarity to the polarity of the first magnet.

6. The relay according to claim 1, wherein the terminal has a yoke attached to the first magnet and forms a magnetic path.

7. The relay according to claim 1,
wherein the relay has a housing configured to support the first terminal, the second terminal and the first magnet, and
wherein the housing has a hold wall configured to hold the first magnet, and the hold wall has a gap between the pair of first contacts.
